(19) United States
(12) Patent Application Publication
(10) Pub. No.: US 2025/0032925 A1
(43) Pub. Date: Jan. 30, 2025

(54) INTERACTIVE ITEM-BASED INTERACTION

(71) Applicant: TENCENT TECHNOLOGY (SHENZHEN) COMPANY LIMITED, Shenzhen (CN)

(72) Inventors: Hengshun ZHAN, Shenzhen (CN); Guanlin HUANG, Shenzhen (CN); Ru XIAO, Shenzhen (CN); Jingxuan CHEN, Shenzhen (CN); Jiawei HUANG, Shenzhen (CN); Qi ZHAO, Shenzhen (CN); Jiakai CHEN, Shenzhen (CN); Guanyu CHEN, Shenzhen (CN)

(73) Assignee: TENCENT TECHNOLOGY (SHENZHEN) COMPANY LIMITED, Shenzhen, GD (CN)

(21) Appl. No.: 18/914,768

(22) Filed: Oct. 14, 2024

Related U.S. Application Data
(63) Continuation of application No. PCT/CN2023/101378, filed on Jun. 20, 2023.

(30) Foreign Application Priority Data
Aug. 23, 2022 (CN) 202211017174.X

(51) Int. Cl. A63F 13/58; A63F 13/52

(52) U.S. Cl. CPC A63F 13/58; A63F 13/52

(57) ABSTRACT

In a method for interaction in a virtual scene, a first virtual character in a first interaction state and an interactive item are displayed in the virtual scene. The first virtual character is transitioned from the first interaction state to a second interaction state when the first virtual character obtains the interactive item. The interactive item is stored when the first virtual character reaches a target location in the virtual scene in the second interaction state. In the first interaction state, the first virtual character is configured to interact with a second virtual character using a target interaction mode, and in the second interaction state, the first virtual character is not configured to interact with the second virtual character using the target interaction mode.

### RELATED APPLICATIONS

The present application is a continuation of International Application No. PCT/CN2023/101378, filed on Jun. 20, 2023, which claims priority to Chinese Patent Application No. 202211017174.X, filed on Aug. 23, 2022. The entire disclosures of the prior applications are hereby incorporated by reference.

### FIELD OF THE TECHNOLOGY

This application relates to the fields of virtualization and human-computer interaction technologies, including a pickable item-based interaction.

### BACKGROUND OF THE DISCLOSURE

In shooting games in the related art, completion of a task goal and victory or defeat of an entire game may be determined based on shooting, kills, rankings, and the like. In other words, core activities encouraged for a player by most shooting games invariably involve direct battle, that is, achieving a kill through shooting. However, engaging exclusively in a single mode of battle interaction leads to a monotonous interaction manner for the player. Consequently, human-computer interaction efficiency is low and utilization of a hardware processing resource and a display resource of a device is low.

### SUMMARY

Embodiments of this disclosure provide a pickable item-based interaction method, apparatus, and a non-transitory computer-readable storage medium to improve human-computer interaction efficiency and utilization of a hardware processing resource and a display resource of a device.

Examples of technical solutions in the embodiments of this disclosure may be implemented as follows.

An aspect of this disclosure provides a method for interaction in a virtual scene. A first virtual character in a first interaction state and an interactive item are displayed in the virtual scene. The first virtual character is transitioned from the first interaction state to a second interaction state when the first virtual character obtains the interactive item. The interactive item is stored when the first virtual character reaches a target location in the virtual scene in the second interaction state. In the first interaction state, the first virtual character is configured to interact with a second virtual character using a target interaction mode, and in the second interaction state, the first virtual character is not configured to interact with the second virtual character using the target interaction mode.

An aspect of this disclosure provides an apparatus. The apparatus includes processing circuitry configured to display a first virtual character in a first interaction state and an interactive item in a virtual scene. The processing circuitry is configured to transition the first virtual character from the first interaction state to a second interaction state when the first virtual character obtains the interactive item. The processing circuitry is configured to store the interactive item when the first virtual character reaches a target location in the virtual scene in the second interaction state. In the first interaction state, the first virtual character is configured to interact with a second virtual character using a target interaction mode, and in the second interaction state, the first virtual character is not configured to interact with the second virtual character using the target interaction mode.

An aspect of this disclosure provides a non-transitory computer-readable storage medium storing instructions which when executed by a processor cause the processor to perform any of the methods of this disclosure.

Embodiments of this disclosure can have the following beneficial effects.

In the foregoing embodiments of this disclosure, the first virtual object in the first interaction state and the pickable item are displayed in the virtual scene. The first virtual object is controlled to switch from the first interaction state to the second interaction state when the first virtual object picks up the pickable item, so that the first virtual object in the second interaction state cannot use the target interaction manner to interact with the second virtual object, and in addition, the pickable item is stored at the target location in the virtual scene. In this way, when the virtual object picks up the pickable item, the interaction state of the virtual object is switched to a new interaction state that limits the interaction manner, so that the virtual object in the new interaction state transports the pickable item to the target location to store the pickable item. An interaction process is implemented by using the pickable item to improve utilization of an item in the virtual scene, thereby improving utilization of a hardware processing resource and a display resource of the electronic device.

### BRIEF DESCRIPTION OF THE DRAWINGS

FIG. 1 is a schematic diagram of an architecture of a pickable item-based interaction system 100 according to an embodiment of this disclosure.

FIG. 2 is a schematic diagram of a structure of an electronic device according to an embodiment of this disclosure.

FIG. 3 is a schematic flowchart of a pickable item-based interaction method according to an embodiment of this disclosure.

FIG. 4 is a schematic diagram of a pickable item according to an embodiment of this disclosure.

FIG. 5 is a schematic diagram of target interaction task selection according to an embodiment of this disclosure.

FIG. 6 is a schematic diagram of a connecting-type task according to an embodiment of this disclosure.

FIG. 7 is a schematic diagram of a synthesis-type task according to an embodiment of this disclosure.

FIG. 8 is a schematic diagram of a catapult-type task according to an embodiment of this disclosure.

FIG. 9 is a schematic diagram of display of picking prompt information according to an embodiment of this disclosure.

FIG. 10 is a schematic diagram of display of victory prompt information according to an embodiment of this disclosure.

FIG. 11 is a schematic diagram of a map of a virtual scene according to an embodiment of this disclosure.

FIG. 12 is a schematic diagram of an application scenario of a pickable item-based interaction method according to an embodiment of this disclosure.

FIG. 13 is a schematic flowchart of a pickable item-based interaction method according to an embodiment of this disclosure.

### DESCRIPTION OF EMBODIMENTS

To make the objectives, technical solutions, and advantages of this disclosure clearer, the following further describes embodiments of this disclosure with reference to the accompanying drawings. The described embodiments are not to be considered as a limitation to embodiments of this disclosure. All other embodiments obtained by a person of ordinary skill in the art shall fall within the protection scope of this disclosure.

In the following description, the term “some embodiments” describes subsets of all possible embodiments, but “some embodiments” may be the same subset or different subsets of all possible embodiments, and may be combined with each other without conflict.

In the following description, the terms “first”, “second”, and “third” are merely intended to distinguish between similar objects rather than describe specific orders. The terms “first”, “second”, and “third” may, where permitted, be interchangeable in a particular order or sequence, so that embodiments of this disclosure described herein may be performed in an order other than that illustrated or described herein.

Unless otherwise defined, meanings of all technical and scientific terms used in this specification are the same as those usually understood by a person skilled in the art to which this disclosure belongs. Terms used in the specification are merely intended to describe objectives of embodiments of this disclosure, but are not intended to limit this disclosure.

Before embodiments of this disclosure are further described in detail, a description is made on terms in embodiments of this disclosure, and the terms in embodiments of this disclosure are applicable to the following explanations. The descriptions of the terms are provided as examples only and are not intended to limit the scope of the disclosure.

(1) Shooting game: includes, but is not limited to, all games using firearm for remote attacks, such as a first-person shooting game and a third-person shooting game.

(2) Third-person perspective: a perspective in which an in-game camera is positioned at a specific distance behind a player character, and the character and all battle elements in a specific surrounding environment may be seen in a picture.

(3) In response to: configured for representing a condition or a state on which a performed operation relies. If the condition or the state is satisfied, one or more performed operations may be real-time or have a set delay. There is no limit to a sequence on the plurality of performed operations unless otherwise specified.

(4) Virtual scene: a virtual scene displayed (or provided) when an application runs on a terminal. The virtual scene may be a simulation environment, a semi-simulation and semi-fictional environment for the real world, or a pure fictional environment. The virtual scene may be any one of a two-dimensional virtual scene, a two-and-a-half-dimensional virtual scene, or a three-dimensional virtual scene.

For example, the virtual scene may include sky, land, and sea. The land may include environmental elements such as a desert and a city. A user may control a virtual object to carry out an activity in the virtual scene. The activity includes but is not limited to: at least one of adjusting a body posture, crawling, walking, running, riding, jumping, driving, picking up, shooting, attacking, or throwing. The virtual scene may be a virtual scene displayed from a first-person perspective (for example, a user's own perspective is used to play a virtual object in a game); may be a virtual scene displayed from a third-person perspective (for example, a user chases a virtual object in a game to play the game); or may be a virtual scene displayed from a bird's-eye perspective. The foregoing perspectives may be switched randomly.

(5) Virtual object: a figure of various people and objects that can be interacted with in a virtual scene, or a movable object in the virtual scene. The movable object may be a virtual character, a virtual animal, and a cartoon character, such as: characters, animals, plants, oil barrels, walls, and stones displayed in the virtual scene. The virtual object may be a virtual figure that is in the virtual scene and is configured for representing a user. The virtual scene may include a plurality of virtual objects, and each virtual object has a shape and a volume in the virtual scene, and occupies a part of space in the virtual scene.

For example, the virtual object may be a user character controlled by an operation performed on a client, or artificial intelligence (AI) set in the virtual scene battle by training, or a non-player character (NPC) set in virtual scene interaction. A quantity of virtual objects participating in the interaction in the virtual scene may be preset or dynamically determined based on a quantity of interactive clients.

(6) Task goal: an activity or an event that a player is encouraged to complete in a game and that is configured for finally determining victory or defeat of the game.

(7) Pickable item: an item that various factions in a virtual scene compete for. When a quantity of target pickable items stored in a virtual base of any faction (for example, a faction A) reaches a quantity threshold (for example, 10), a game ends and faction A wins the game.

(8) Virtual base: a location or a virtual building configured for storing a target pickable item in a virtual scene. Each faction has at least one corresponding virtual base in the virtual scene. In addition, a virtual object included in each faction is born and resurrected in the virtual base of the corresponding faction.

(9) Client: an application, such as a video playback client or a game client, running in a terminal device for providing various services.

In most shooting games in related art, game modes include a game mode with shooting and killing an enemy as a task goal, a game mode without shooting and killing an enemy as a task goal such as escorting a target point or occupying a target point, and a game mode with collecting an item as a task goal to win. However, for the first game mode, completion of the task goal and victory or defeat of an entire game are mainly determined based on shooting, kills, rankings, and the like. For the second game mode, it is only a disguised limitation on a region and a condition for the player to battle. Essentially, killing by shooting is still a core activity of the player. For the third game mode, shooting is not changed as a first core element for the player at any time of the game. In other words, a micro activity and battle manner of the player never change. In other words, core activities encouraged for a player by most shooting games invariably involve direct battle, that is, achieving a kill through shooting. However, engaging exclusively in a single mode of battle interaction leads to a monotonous interaction process for the player. Consequently, human-computer interaction efficiency is low.

In view of this, this disclosure provides a pickable item-based interaction method and apparatus, an electronic device, a computer-readable storage medium, and a computer program product. The player is encouraged to perform activities other than shooting. In other words, a task as an alternative to killing is provided, and changes in the task goal and the battle manner are combined, to create different battle experience for the player, provide rich tactical decision-making space, and increase diversity and strategy of the match. This provides the player with freshness, and provides the player with a high level of spiritual satisfaction other than a direct pleasure brought by a shooting battle.

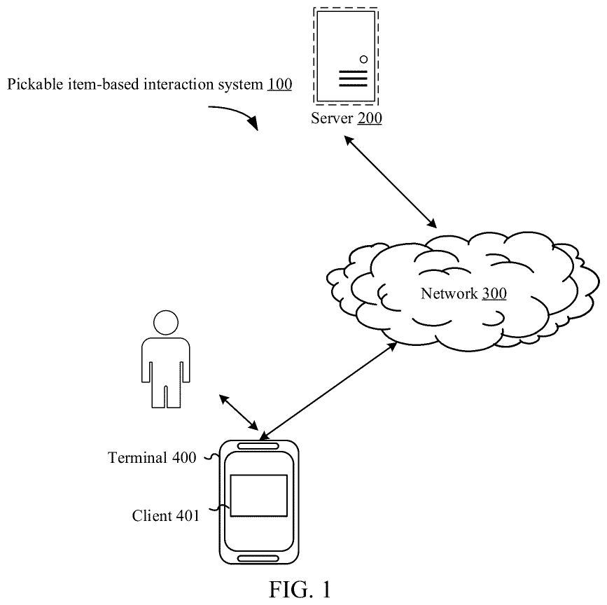

FIG. 1 is a schematic diagram of an architecture of a pickable item-based interaction system 100 according to an embodiment of this disclosure. To implement a pickable item-based interaction application scenario (for example, the pickable item-based interaction application scenario may be an application scenario for resource processing based on a virtual scene in a game APP, for example, when a player plays the game APP, a pickable item such as a task ball is displayed in the virtual scene. When the player in a first interaction state, such as a shooting state, picks up the task ball, the player is controlled to switch from the first interaction state, such as the shooting state, to a second interaction state, such as a non-shooting state, and the task ball is stored when the player in the non-shooting state is located at a target location in the virtual scene, such as a virtual base.), a pickable item-based interaction client 401 (that is, the game APP) is provided on a terminal (a terminal 400 is shown as an example). The terminal 400 is connected to a server 200 via a network 300. The network 300 may be a wide area network or a local area network, or a combination thereof, and data transmission is implemented by using a wireless or wired link.

The terminal 400 is configured to send, in response to a trigger operation on a virtual scene including a virtual object in a first interaction state and a pickable item, an acquiring request for scene data corresponding to the virtual scene to the server 200.

The server 200 is configured to send, based on the received acquiring request for the scene data, the scene data including the virtual object in the first interaction state and the pickable item to the terminal 400.

The terminal 400 is further configured to receive the scene data including the virtual object in the first interaction state and the pickable item, and present the corresponding virtual scene; display, in an interaction match in a virtual scene, a first virtual object in a first interaction state and a pickable item, the first interaction state being a state in which the first virtual object can interact with a second virtual object in a target interaction manner; control the first virtual object to switch from the first interaction state to a second interaction state when the first virtual object picks up the pickable item, the second interaction state being a state in which the first virtual object cannot interact with the second virtual object in the target interaction manner; and store the pickable item when the first virtual object in the second interaction state is located at a target location in the virtual scene.

In some embodiments, the server 200 may be an independent physical server, a server cluster or distributed system composed of a plurality of physical servers, or a cloud server providing basic cloud computing services, such as cloud services, cloud databases, cloud computing, cloud functions, cloud storage, network services, cloud communications, middleware services, domain name services, security services, content delivery networks (CDNs), and big data and artificial intelligence platforms. The terminal 400 may be but is not limited to a smartphone, a tablet computer, a notebook computer, a desktop computer, a set-top box, an intelligent voice interaction device, a smart home appliance, an on-board terminal, an aircraft, a mobile device (for example, a mobile phone, a portable music player, a personal digital assistant, a dedicated messaging device, a portable gaming device, a smart speaker, and a smartwatch), and the like. The terminal device and the server may be connected directly or indirectly in a wired or wireless communication manner, which is not limited in embodiments of this disclosure.

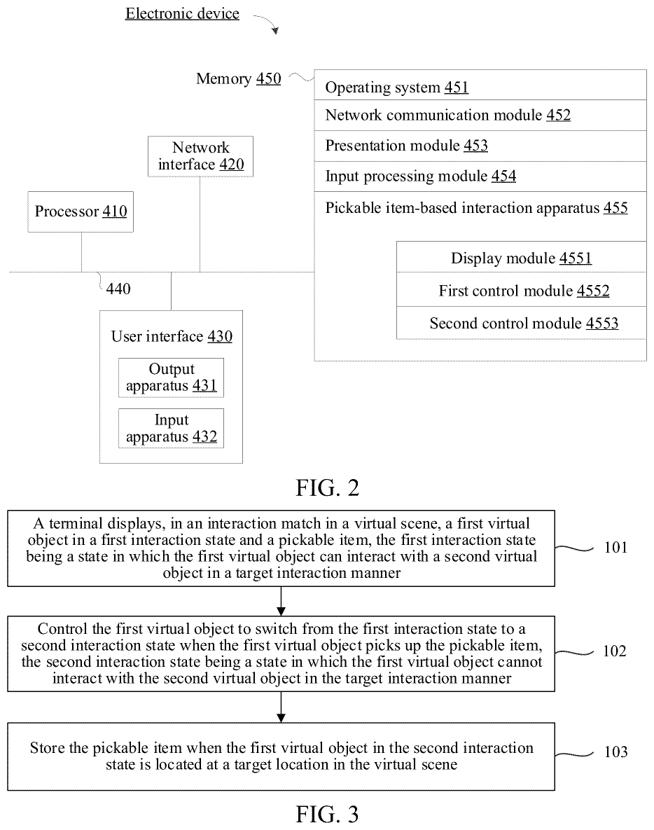

The following describes an electronic device that implements a pickable item-based interaction method according to an embodiment of this disclosure. FIG. 2 is a schematic diagram of a structure of an electronic device according to an embodiment of this disclosure. An example in which the electronic device is the terminal shown in FIG. 1 is used and the electronic device shown in FIG. 2 includes at least one processor 410 (e.g., processing circuitry), a memory 450 (e.g., a non-transitory computer-readable storage medium), at least one network interface 420, and a user interface 430. Components in the terminal 400 are coupled together via a bus system 440. The bus system 440 is configured to implement connection and communication between the components. In addition to a data bus, the bus system 440 further includes a power bus, a control bus, and a state signal bus. However, for clarity, various buses are marked as the bus system 440 in FIG. 2.

The processor 410 may be an integrated circuit chip with a signal processing capability, such as a general-purpose processor, a digital signal processor (DSP), or another programmable logic device, discrete gate or transistor logic device, or discrete hardware component. The general-purpose processor may be a microprocessor, any conventional processor, or the like.

The user interface 430 includes one or more output apparatuses 431 that display media content, including one or more speakers and/or one or more visual display screens. The user interface 430 further includes one or more input apparatuses 432, including user interface members that facilitate a user input, such as a keyboard, a mouse, a microphone, a touch display screen, a camera, and another input button and control.

The memory 450 may be removable, non-removable, or a combination thereof. For example, a hardware device includes a solid-state memory, a hard disk drive, and an optical drive. The memory 450 in some embodiments includes one or more storage devices physically located away from the processor 410.

The memory 450 may include a volatile memory or a non-volatile memory, or may include both the volatile memory and the non-volatile memory. The non-volatile memory may be a read-only read (ROM), and the volatile memory may be a random-access memory (RAM). The memory 450 described in this embodiment of this disclosure aims to include any suitable memory.

In some embodiments, the memory 450 can store data to support various operations, examples of the data include programs, modules, data structures, or subsets or supersets of the data. An example is as follows:

An operating system 451 includes a system program configured to process various basic system services and perform hardware-related tasks, such as a framework layer, a core library layer, and a driver layer, and is configured to implement various basic services and process hardware-based tasks.

A network communication module 452 is configured to reach another electronic device via one or more (wired or wireless) network interfaces 420. For example, the network interface 420 includes Bluetooth, Wi-Fi, or a universal serial bus (USB).

A presentation module 453 is configured to display information by one or more output apparatuses 431 (for example, display screens and speakers) associated with the user interface 430 (for example, a user interface configured to operate a peripheral device and display content and information).

An input processing module 454 is configured to detect one or more user inputs or interactions from the input apparatus 432 and translate the detected inputs or interactions.

In some embodiments, an apparatus provided in this embodiment of this disclosure may be implemented in a software manner. FIG. 2 shows a pickable item-based interaction apparatus 455 stored in the memory 450. The apparatus 455 may be software in the form of a program and a plug-in, and includes the following software modules: a display module 4551, a first control module 4552, and a second control module 4553. These modules are logical, so that the modules can be arbitrarily combined or further split according to achieved functions. The functions of the modules are described below.

In some other embodiments, the apparatus provided in this embodiment of this disclosure may be implemented in a hardware manner. As an example, the pickable item-based interaction apparatus provided in this embodiment of this disclosure may be a processor in the form of a hardware decoding processor that is programmed to perform the pickable item-based interaction method provided in this embodiment of this disclosure. For example, the processor in the form of a hardware decoding processor may use one or more application-specific integrated circuits (ASICs), a DSP, a programmable logic device (PLD), a complex programmable logic device (CPLD), a field-programmable gate array (FPGA), or another electronic element.

In some embodiments, the terminal or the server may implement the pickable item-based interaction method provided in embodiments of this disclosure by running a computer program. For example, the computer program may be a native program or a software module in an operating system; may be a native application (APP), to be specific, a program that needs to be installed in the operating system to run, such as an instant messaging APP, and a web browser APP; may be a mini program, to be specific, a program that only needs to be downloaded into a browser environment to run; or may be a mini program that can be embedded in any APP. In conclusion, the foregoing computer program may be any form of application program, module, or plug-in.

Based on the foregoing descriptions of the pickable item-based interaction system and the electronic device provided in this embodiment of this disclosure, the following describes the pickable item-based interaction method provided in an embodiment of this disclosure. In actual implementation, the pickable item-based interaction method provided in this embodiment of this disclosure may be implemented by a terminal or a server alone, or by a terminal and a server collaboratively. An example in which the terminal 400 in FIG. 1 performs the pickable item-based interaction method provided in this embodiment of this disclosure alone is used for description. FIG. 3 is a schematic flowchart of a pickable item-based interaction method according to an embodiment of this disclosure, which is described with reference to operations shown in FIG. 3.

Operation 101: A terminal displays, in an interaction match in a virtual scene, a first virtual object in a first interaction state and a pickable item, the first interaction state being a state in which the first virtual object can interact with a second virtual object in a target interaction manner. For example, a first virtual character in a first interaction state and an interactive item are displayed in the virtual scene.

In actual implementation, an application that supports a virtual scene is installed on the terminal. The application may be any one of a first-person shooting game, a third-person shooting game, a multiplayer online battle arena game, a virtual reality application, a three-dimensional map program, or a multiplayer gunfight survival game. A user may use the terminal to operate a virtual object in the virtual scene to carry out an activity.

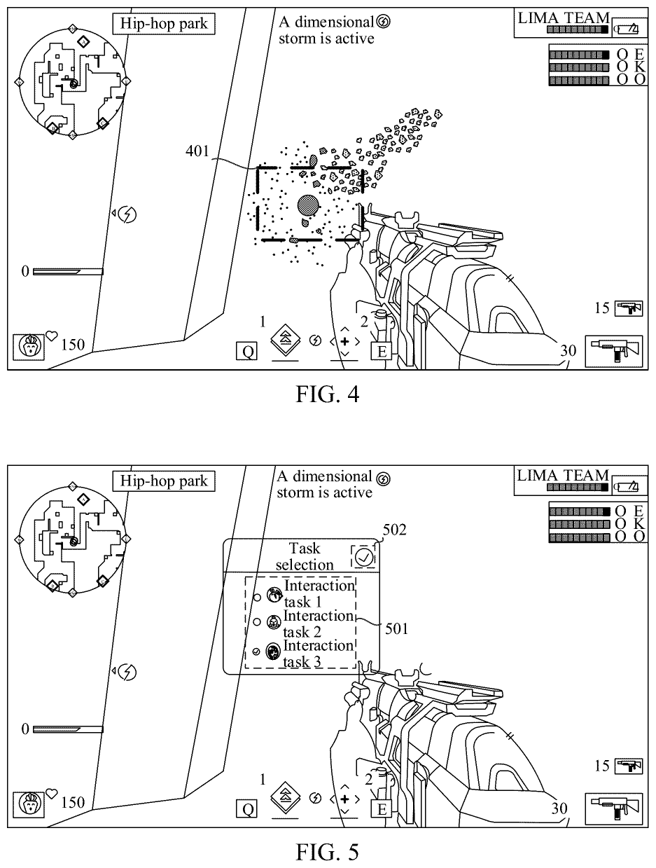

When the user opens the application on the terminal and the terminal runs the application, the terminal presents a virtual scene picture. The virtual scene picture is acquired by observing the virtual scene from a first-person object perspective, or by observing the virtual scene from a third-person perspective. The virtual scene picture includes the first virtual object in the first interaction state and the pickable item. The first virtual object may be a player character controlled by a current player, or may be a player character controlled by another player (teammate) who belongs to the same group as the current player. The pickable item may be an item that can be picked up by a virtual object in the virtual scene, such as a ball, an attack item, or a defense item. For example, FIG. 4 is a schematic diagram of a pickable item according to an embodiment of this disclosure. According to FIG. 4, an item in a dashed box 401 is a pickable item.

The first virtual object belongs to a first faction, and the second virtual object belongs to a second faction. The first faction and the second faction fight against each other in the interaction match. In other words, the first faction and the second faction are opposing factions. The target interaction manner here may be an interaction manner using a target item such as a shooting item, or an interaction manner using a target skill such as a long-range attack. When the target interaction manner is an interaction manner based on a shooting item, the first interaction state is a state in which the first virtual object can use the shooting item to shoot the second virtual object, and a second interaction state is a state in which the first virtual object cannot use the shooting item to shoot the second virtual object, but can hold the pickable item to attack the second virtual object.

In actual application, the first interaction state and the second interaction state are specifically defined, to increase diversity in an interaction process, and improve user's immersion and interaction experience, thereby improving human-computer interaction efficiency and utilization of a hardware resource of an electronic device.

In actual implementation, the pickable item in the virtual scene may be directly generated by the terminal when presenting the virtual scene, or may be generated by triggering a conversion condition of the pickable item. The following describes a process of displaying the pickable item.

In some embodiments, in a case that the pickable item is generated by triggering the conversion condition of the pickable item, the process of displaying the pickable item in the virtual scene specifically includes: displaying, in the virtual scene, a virtual natural element belonging to a natural phenomenon; and controlling the virtual natural element to be converted into the pickable item when a condition for converting the virtual natural element is satisfied. For example, when a virtual natural phenomenon is a virtual tornado, a virtual natural element belonging to the virtual tornado is displayed in the virtual scene. When the virtual natural phenomenon is a virtual volcano, a virtual natural element belonging to the virtual volcano is displayed in the virtual scene.

According to the foregoing embodiment, the virtual natural element is converted into the pickable item, so that diversity of an interaction process in the virtual scene is increased, and entertainment value of a process of displaying the pickable item is increased, thereby improving human-computer interaction efficiency and utilization of a hardware resource of an electronic device.

In actual implementation, the condition for converting the virtual natural element may be determined by a distance between the first virtual object and the virtual natural element, or may be determined by a result of an interaction task corresponding to the virtual natural element performed by the first virtual object.

In a case that the condition for converting the virtual natural element is determined by the distance between the first virtual object and the virtual natural element, a process of controlling the virtual natural element to be converted into the pickable item when the condition for converting the virtual natural element is satisfied specifically includes: controlling the first virtual object to move toward the virtual natural element in response to a movement instruction for the first virtual object; and controlling the virtual natural element to be converted into the pickable item when the first virtual object is within an induction region of the virtual natural element.

The induction region of the virtual natural element may be a circular region with a location of the virtual natural element as a center and a target distance as a radius. The target distance here is preset, such as five meters.

According to the foregoing embodiment, the condition for converting the virtual natural element is defined. To be specific, the virtual natural element is controlled to be converted into the pickable item when the first virtual object is within the induction region of the virtual natural element, so that diversity of an interaction process in the virtual scene and initiative of the user exploring in the virtual scene are improved, thereby improving human-computer interaction efficiency and utilization of a hardware resource of an electronic device.

In a case that the condition for converting the virtual natural element is determined by the result of the interaction task corresponding to the virtual natural element performed by the first virtual object, a process of controlling the virtual natural element to be converted into the pickable item when the condition for converting the virtual natural element is satisfied specifically includes: controlling the first virtual object to move toward the virtual natural element in response to a movement instruction for the first virtual object; displaying the interaction task corresponding to the virtual natural element when the first virtual object is within the induction region of the virtual natural element; controlling the first virtual object to perform the interaction task in response to a control instruction for the first virtual object; and controlling the virtual natural element to be converted into the pickable item when the interaction task is completed. For example, the virtual natural element is displayed when the virtual natural phenomenon to which the virtual natural element belongs is ice, and the interaction task, such as breaking the ice, corresponding to the virtual natural element is displayed when the first virtual object is within the induction region of the virtual natural element, so that the first virtual object is controlled to break the ice in response to the control instruction for the first virtual object, and the ice is controlled to be converted into the pickable item when the ice is broken.

A process of determining that the first virtual object is within an induction range of the virtual natural element specifically includes: The terminal acquires a location of the first virtual object in the virtual scene, a location of the virtual natural element, and the induction range of the virtual natural element, determines a distance between the first virtual object and the virtual natural element based on the location of the first virtual object in the virtual scene and the location of the virtual natural element, and determines, based on the distance, that the first virtual object is within the induction range of the virtual natural element.

In actual implementation, after the location of the first virtual object in the virtual scene, the location of the virtual natural element, and the induction range of the virtual natural element are acquired, the distance between the first virtual object and the virtual natural element is acquired based on the location of the first virtual object and the location of the virtual natural element, and the distance is compared with a target distance indicated by the induction range of the virtual natural element. In this way, when the distance is less than or equal to the target distance indicated by the induction range of the virtual natural element, it is determined that the first virtual object is within the induction range of the virtual natural element; and when the distance is greater than the target distance indicated by the induction range of the virtual natural element, it is determined that the first virtual object is not within the induction range of the virtual natural element.

In some other embodiments, in a case that the pickable item is directly generated when the virtual scene is presented, a process of displaying the pickable item in the virtual scene specifically includes: periodically generating, in the virtual scene, the pickable item, and displaying the generated pickable item after each generation.

In actual implementation, a period here is preset. A generation time point of the pickable item and a preset period are acquired when the pickable item is displayed. When it is determined, based on the period and the generation time point of the pickable item, that a time point at which the pickable item is generated again is reached, the pickable item is generated. The virtual natural element belonging to the virtual natural phenomenon is randomly generated in the virtual scene before the pickable item is generated and displayed, so that when the pickable item is generated, the pickable item is randomly displayed on the virtual natural element belonging to the virtual natural phenomenon.

In actual application, the pickable item is periodically generated to reduce time for the first virtual object to find the pickable item, so that diversity of the interaction process in the virtual scene is improved, gaming experience of the user is increased, and human-computer interaction efficiency and utilization of a hardware resource of an electronic device are improved.

In actual implementation, in the virtual scene, after the first virtual object in the first interaction state and the pickable item are displayed, the first virtual object is controlled to move toward the pickable item in response to a movement instruction for the first virtual object; and the first virtual object is controlled to pick up the pickable item when the first virtual object is located in the induction region of the pickable item. The induction region of the pickable item here may be a circular region with a location of the pickable item as a center and a target distance as a radius. The target distance here is preset, such as five meters.

A process of determining that the first virtual object is within an induction range of the pickable item specifically includes: The terminal acquires a location of the first virtual object in the virtual scene, a location of the pickable item, and the induction range of the pickable item, determines a distance between the first virtual object and the pickable item based on the location of the first virtual object in the virtual scene and the location of the pickable item, and determines, based on the distance, that the first virtual object is within the induction range of the pickable item.

In actual implementation, after the location of the first virtual object in the virtual scene, the location of the pickable item, and the induction range of the pickable item are acquired, the distance between the first virtual object and the pickable item is acquired based on the location of the first virtual object and the location of the pickable item, and the distance is compared with a target distance indicated by the induction range of the pickable item. In this way, when the distance is less than or equal to the target distance indicated by the induction range of the pickable item, it is determined that the first virtual object is within the induction range of the pickable item; and when the distance is greater than the target distance indicated by the induction range of the pickable item, it is determined that the first virtual object is not within the induction range of the pickable item.

According to the foregoing embodiment, the first virtual object is controlled to pick up the pickable item when the first virtual object is within the induction region of the pickable item, so that diversity of an interaction process in the virtual scene and initiative of the user exploring in the virtual scene are improved, thereby improving human-computer interaction efficiency and utilization of a hardware resource of an electronic device.

In actual implementation, when the first virtual object is within the induction region of the pickable item, in addition to directly controlling the first virtual object to pick up the pickable item, an interaction task corresponding to the pickable item may alternatively be displayed; the first virtual object is controlled to perform the interaction task in response to a control instruction for the first virtual object; and the first virtual object is controlled to pick up the pickable item when the interaction task is completed.

When there is a plurality of interaction tasks, a target interaction task may alternatively be determined from the plurality of interaction tasks. Specifically, when there is the plurality of interaction tasks, task options for the interaction tasks are displayed. In response to a selection operation on a target task option among the plurality of task options, a target interaction task corresponding to the target task option is selected as the interaction task performed by the virtual object.

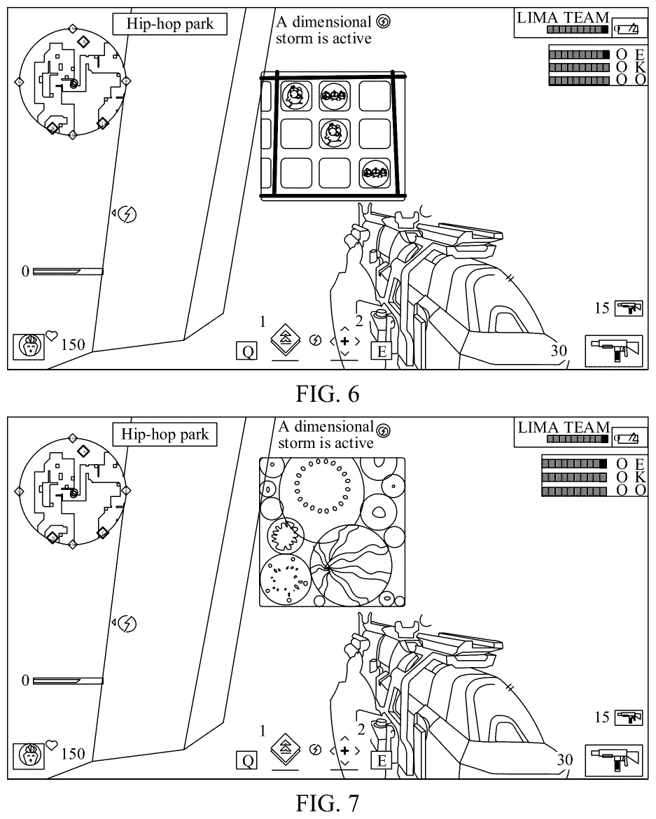

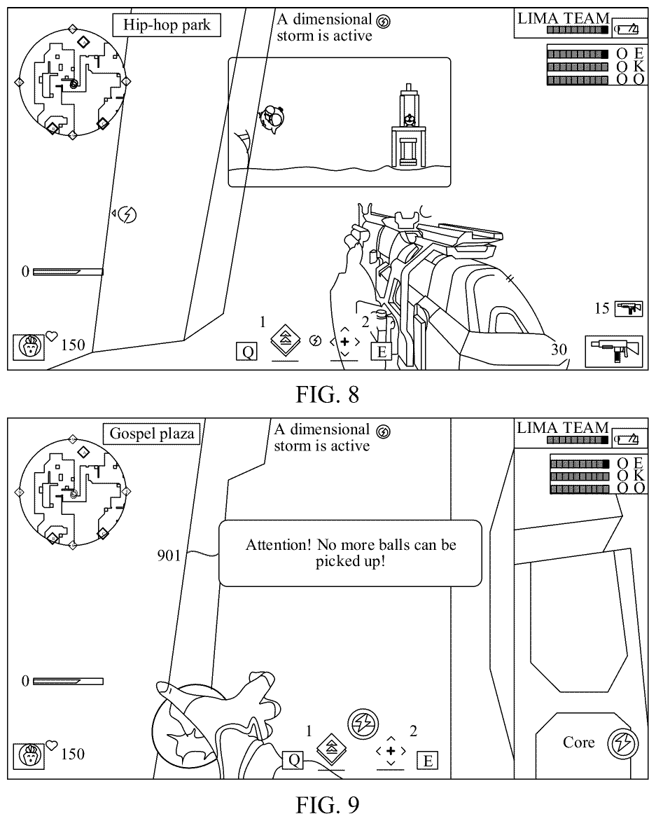

For example, FIG. 5 is a schematic diagram of target interaction task selection according to an embodiment of this disclosure. According to FIG. 5, there are three interaction tasks. Options in a dashed box 501 are task options for all the interaction tasks. For example, an interaction task corresponding to interaction task 1 may be a connecting-type task. FIG. 6 is a schematic diagram of a connecting-type task according to an embodiment of this disclosure. An interaction task corresponding to interaction task 2 may be a synthesis-type task. For example, FIG. 7 is a schematic diagram of a synthesis-type task according to an embodiment of this disclosure. An interaction task corresponding to interaction task 3 may be a catapult-type task. For example, FIG. 8 is a schematic diagram of a catapult-type task according to an embodiment of this disclosure. According to FIG. 5, an option corresponding to interaction task 3 is selected from the options for the three interaction tasks, so that interaction task 3 is used as an interaction task performed by the first virtual object.

In actual implementation, when the task options for all the interaction tasks are presented, a confirmation function item for confirming that selection for a target interaction task is completed is also displayed. Still refer to FIG. 5. According to FIG. 5, a function item in a dashed box 502 is a confirmation function item for confirming that selection for a target interaction task is completed. After interaction task 3 is used as the interaction task performed by the first virtual object, when a trigger operation on the confirmation function item is received, it is confirmed that the selection for the target interaction task is completed.

As shown in FIG. 6, FIG. 7, and FIG. 8, after a task to be performed is determined, a process of performing the interaction task by the first virtual object is displayed in the virtual scene. There is a corresponding task goal for each interaction task. When the first virtual object achieves or completes the task goal, it is determined that the interaction task is completed.

In actual application, compared to that the first virtual object is directly controlled to pick up the pickable item, the interaction task is set to control the first virtual object to pick up the pickable item when the first virtual object completes the interaction task, so that diversity of an interaction process in the virtual scene and initiative of the user interacting in the virtual scene are improved, thereby improving gaming experience of the user, human-computer interaction efficiency, and utilization of a hardware resource of an electronic device.

Operation 102: Control the first virtual object to switch from the first interaction state to a second interaction state when the first virtual object picks up the pickable item, the second interaction state being a state in which the first virtual object cannot interact with the second virtual object in the target interaction manner. For example, the first virtual character is transitioned from the first interaction state to a second interaction state when the first virtual character obtains the interactive item. For example, in the first interaction state, the first virtual character is configured to interact with a second virtual character using a target interaction mode, and in the second interaction state, the first virtual character is not configured to interact with the second virtual character using the target interaction mode.

When the first virtual object picks up the pickable item, indicating that when the first virtual object completes a picking operation on the pickable item, in other words, in response to a picking instruction for the pickable item, the first virtual object is controlled to pick up the pickable item; and the first virtual object is controlled to switch from the first interaction state to the second interaction state when the first virtual object complete the picking operation on the pickable item. Controlling the first virtual object to pick up the pickable item is controlling the first virtual object to perform the picking operation on the pickable item. Picking duration is displayed from time the first virtual object performs the picking operation. When the picking duration satisfies target picking duration such as 3 seconds, it is determined that the first virtual object completes the picking operation on the pickable item.

The second virtual object and the first virtual object belong to different factions or groups. The target interaction manner may be an interaction manner using a target item such as a shooting item, or using a target skill such as a lone-range attack.

In actual implementation, after the first virtual object is controlled to switch from the first interaction state to the second interaction state, the first virtual object may interact with another virtual object by using various interaction manners. The following describes a process of the first virtual object interacting with another virtual object by using various manners.

In some embodiments, after the first virtual object is controlled to switch from the first interaction state to the second interaction state, the first virtual object is controlled to perform target motion in response to a motion instruction for the first virtual object when the second virtual object performs an attack operation on the first virtual object in the target interaction manner, the target motion being for enabling the first virtual object to avoid the attack operation.

The first virtual object being controlled to perform the target motion may be that the first virtual object is controlled to perform an action such as jumping or moving, to avoid the attack operation performed by the second virtual object in the target interaction manner by jumping or moving. The attack operation performed by the second virtual object in a manner other than the target interaction manner may alternatively be avoided by jumping or moving.

When the first virtual object is in the second interaction state, an action attribute of an action such as jumping or moving of the first virtual object performing the target motion is improved. For example, a jumping capability is improved, and movement speed is accelerated, so that capabilities of a close battle and displacement are improved, thereby increasing diversity of an interaction process.

According to the foregoing embodiment, the first virtual object is controlled to perform the action such as jumping or moving, to avoid the attack operation performed by the second virtual object in the target interaction manner, so that diversity of an interaction process in the virtual scene is increased, thereby improving human-computer interaction efficiency and utilization of a hardware resource of an electronic device.

In actual implementation, the pickable item is controlled to be transferred from the first virtual object to the second virtual object when the first virtual object is killed by the attack operation performed by the second virtual object. A process of controlling the pickable item to be transferred from the first virtual object to the second virtual object when the first virtual object is killed by the attack operation performed by the second virtual object may be specifically that the pickable item is displayed at a location in which the first virtual object is killed when the first virtual object is killed by the attack operation performed by the second virtual object; then a scene in which the second virtual object moves to the pickable item is displayed; and the pickable item is controlled to be transferred to the second virtual object when the second virtual object moves to the induction region of the pickable item. A virtual resource used as a reward may be further displayed when the first virtual object is killed, the virtual resource being used in the virtual scene; and the virtual resource is received in response to a receiving operation on the virtual resource. The virtual resource may be an item configured to perform an interaction operation on a virtual object, experience points that improve a level of the virtual object, or the like.

In actual application, the pickable item is controlled to be transferred from the first virtual object to the second virtual object when the first virtual object is killed by the attack operation performed by the second virtual object, to increase a pickable item-based interaction manner, and improve interaction initiative between the first virtual object and the second virtual object based on the pickable item, thereby improving human-computer interaction efficiency and utilization of a hardware resource of an electronic device.

In some embodiments, after the first virtual object is controlled to switch from the first interaction state to the second interaction state, the first virtual object is controlled to throw the pickable item to a third virtual object in response to a throwing instruction for the pickable item, the throwing being for transferring the pickable item from the first virtual object to the third virtual object, and the third virtual object and the first virtual object belonging to the same faction or group.

In actual implementation, after the first virtual object is controlled to throw the pickable item to the third virtual object, the first virtual object is controlled to switch from the second interaction state to the first interaction state, so that the first virtual object can interact with the second virtual object by using the target interaction manner. In this way, the pickable item is transferred between virtual objects in the same faction, to ensure that the pickable item is held, and ensure that there is a virtual object in the same faction can interact with virtual objects in different factions by using the target interaction manner.

According to the foregoing embodiment, the pickable item is transferred between the virtual objects by using the throwing operation, to increase a pickable item-based interaction manner, reduce a possibility of the second virtual object acquiring the pickable item, and improve interaction initiative between the virtual objects, thereby improving efficiency of human-computer interaction and utilization of a hardware resource of an electronic device.

In some embodiments, when the target interaction manner is configured for indicating that the first virtual object interacts with the second virtual object by using the target item such as a shooting item, after the first virtual object is controlled to switch from the first interaction state to the second interaction state, the first virtual object is controlled to throw the pickable item toward the second virtual object in response to the throwing instruction for the pickable item when the second virtual object uses the target item to perform the attack operation on the first virtual object; and the second virtual object is controlled to switch from the first interaction state to the second interaction state when the pickable item is thrown to the second virtual object.

After the first virtual object is controlled to switch from the first interaction state to the second interaction state, the first virtual object loses a capability such as a shooting capability to interact with another virtual object by using the target item. In this case, the first virtual object is controlled to throw the pickable item toward the second virtual object to cause the second virtual object to switch from the first interaction state to the second interaction state, so that the second virtual object loses a capability such as a shooting capability to interact with another virtual object by using the target item.

In actual application, the pickable item is thrown to the second virtual object to cause the second virtual object to lose the capability such as a shooting capability to interact with another virtual object by using the target item, to improve a possibility of the first virtual object killing the second virtual object, increase a pickable item-based interaction manner, and improve efficiency of human-computer interaction and utilization of a hardware resource of an electronic device.

In actual implementation, the first virtual object may be further controlled to switch from the second interaction state to the first interaction state when the pickable item is thrown to the second virtual object; and the first virtual object is controlled, in response to an interaction instruction for the first virtual object, to interact with the second virtual object by using the target item. The first virtual object is controlled to switch from the second interaction state to the first interaction state when the pickable item is thrown to the second virtual object. In other words, the first virtual object acquires the capability such as a shooting capability to interact with another virtual object by using the target item. In this case, the first virtual object is controlled to interact with the second virtual object by using the target item, such as shooting the second virtual object. Because the second virtual object switches from the first interaction state to the second interaction state, in other words, the second virtual object loses the capability such as a shooting capability to interact with another virtual object by using the target item, a possibility of the first virtual object killing the second virtual object is improved, and diversity of an interaction process between virtual objects is increased.

According to the foregoing embodiment, when the pickable item is thrown to the second virtual object, the first virtual object acquires the capability such as a shooting capability to interact with another virtual object by using the target item. In this way, a possibility of the first virtual object killing the second virtual object is improved, diversity of an interaction process between virtual objects is increased.

In some embodiments, a quantity of pickable items that a virtual object picks up may be further set. Specifically, when the first virtual object is in the second interaction state, picking prompt information is displayed in response to the first virtual object picking up another pickable item in the virtual scene, the picking prompt information being configured for prompting that a quantity of pickable items carried by the first virtual object reaches a quantity threshold. The quantity threshold here is preset, such as one or three. For example, FIG. 9 is a schematic diagram of display of picking prompt information according to an embodiment of this disclosure. According to FIG. 9, information in a solid box 901 is displayed picking prompt information, so that it is prompted, based on the picking prompt information, that a quantity of pickable items carried by the first virtual object reaches a quantity threshold.

In actual application, the quantity of pickable items that the virtual object picks up is set, to display the picking prompt information when the quantity of pickable items carried by the first virtual object reaches the quantity threshold. In this way, it is reminded in time by using the picking prompt information that the quantity of pickable items carried by the first virtual object reaches the quantity threshold, to improve the user's immersion and interaction experience.

Operation 103: Store the pickable item when the first virtual object in the second interaction state is located at a target location in the virtual scene. For example, the interactive item is stored when the first virtual character reaches a target location in the virtual scene in the second interaction state.

The pickable item is configured for determining an interaction result between the first virtual object and the second virtual object for the interaction match. A process of determining the interaction result between the first virtual object and the second virtual object for the interaction match based on the pickable item may be determined based on a quantity of stored pickable items, that is, a quantity of target pickable items. Specifically, the quantity of stored target pickable items is acquired. When the quantity of stored target pickable items reaches a quantity threshold, a corresponding virtual object is determined to win. Duration of the interaction match may be preset, so that within the preset duration, when a quantity of target pickable items stored at a target location corresponding to any virtual object reaches the quantity threshold, a virtual object corresponding to a corresponding target location is determined to win. The target location may be a preset virtual base corresponding to a faction at which a corresponding virtual object is located, and a location such as a center location of the virtual base for storing the pickable item at the target location may also be preset. When the quantity of target pickable items stored at the target location corresponding to no virtual object reaches the quantity threshold during the preset duration, the interaction match may be determined to be a draw. Quantities of target pickable items stored in target locations may alternatively be compared to determine a virtual object corresponding to a target location with the largest quantity of stored target pickable items, so that the virtual object is determined to win.

In actual implementation, the pickable item is stored when the first virtual object in the second interaction state reaches the target location in the virtual scene; or when the first virtual object in the second interaction state is at the target location in the virtual scene, the first virtual object is controlled to move to a location in the target location and for storing the pickable item, to store the pickable item.

The storing here is for indicating that the pickable item is placed in the location in the target location and for storing the pickable item. In other words, the pickable item is displayed at the location in the target location and for storing the pickable item. In addition, a quantity of placed pickable items may be further displayed at the location in the target location and for storing the pickable item. When a pickable item is placed in the location in the target location and for storing the pickable item, a quantity of displayed and placed pickable items is controlled to be increased by one. In addition, whether the pickable item is stored when the first virtual object reaches the target location in the virtual scene, or the pickable item is stored when the first virtual object moves to the location in the target location and for storing the pickable item, the pickable item may be directly stored. Alternatively, duration of the first virtual object being at a corresponding location may be displayed. When the duration reaches a duration threshold, such as 3 seconds or 5 seconds, the pickable item may be stored. Specifically, the duration of the first virtual object being at the corresponding location is acquired, and the duration is compared with the duration threshold. When a comparison result indicates that the duration of the first virtual object being at the corresponding location reaches the duration threshold, the pickable item is stored.

In some embodiments, after the pickable item is stored, an area of a region corresponding to the target location in the virtual scene is acquired, and the region is expanded, the area of the region being positively correlated with a quantity of target pickable items stored at the target location. The target pickable item stored at the target location is carried to the target location by a corresponding virtual object. For example, a target correspondence between the quantity of target pickable items stored in the virtual base and an area of a region corresponding to the virtual base in the virtual scene is preset. When the target location is a virtual base corresponding to the first virtual object in the virtual scene, and the quantity of target pickable items stored in the virtual base increases, an increased total quantity of target pickable items stored in the virtual base and a target correspondence are acquired. An area corresponding to the total quantity is acquired based on the target correspondence, so that the area of the region corresponding to the virtual base in the virtual scene is correspondingly expanded. When the quantity of target pickable items stored in the virtual base decreases, a decreased total quantity of target pickable items stored in the virtual base and a target correspondence are acquired. An area corresponding to the total quantity is acquired based on the target correspondence, so that the area of the region corresponding to the virtual base in the virtual scene is correspondingly reduced.

According to the foregoing embodiment, the area of the region corresponding to the virtual base in the virtual scene is adjusted based on the quantity of target pickable items stored in the virtual base, to increase initiative of the user acquiring and storing more pickable items, thereby improving the user's immersion and interaction experience, as well as efficiency of human-computer interaction and utilization of a hardware resource of an electronic device.

When the quantity of target pickable items stored at the target location increases, a battle attribute of the corresponding virtual object is also enhanced. In other words, the battle attribute of the virtual object is positively correlated with the quantity of target pickable items stored at the target location. For example, a larger quantity of target pickable items stored at the target location indicates a higher level of the corresponding virtual object, or a higher damage caused by attacking another virtual object.

In some embodiments, after the pickable item is stored, a virtual resource used as a reward may be further displayed, the virtual resource here being a reward for storing the pickable item, and the virtual resource being used in the virtual scene; and the virtual resource is received in response to a receiving operation on the virtual resource. The virtual resource may be an item configured to perform an interaction operation on a virtual object, experience points that improve a level of the virtual object, or the like.

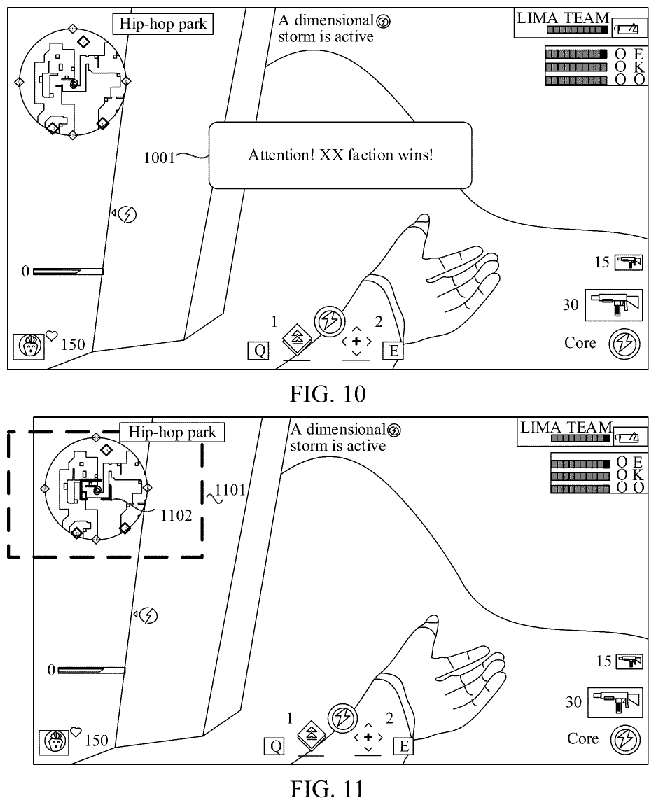

In some embodiments, at least two factions exist in the virtual scene, each faction has a corresponding virtual base in the virtual scene, the at least two factions each have a picking task for the pickable item, and the target location is a virtual base corresponding to a faction to which the first virtual object belongs. Victory prompt information is displayed when a quantity of target pickable items stored in the faction to which the first virtual object belongs reaches a quantity threshold, the victory prompt information being configured for prompting that the faction to which the first virtual object belongs wins the picking task. When a quantity of target pickable items stored in any virtual base in the virtual scene reaches the quantity threshold such as 10, victory prompt information of a faction corresponding to a corresponding virtual base is displayed. For example, FIG. 10 is a schematic diagram of display of victory prompt information according to an embodiment of this disclosure. According to FIG. 10, information in a solid box 1001 is victory prompt information of a corresponding faction.

In actual application, a quantity of target pickable items stored in a faction is used to determine whether the faction at which a virtual object is located wins, so that initiative of the user acquiring and storing more pickable items is increased, thereby improving efficiency of human-computer interaction and utilization of a hardware resource of an electronic device.

In some embodiments, the virtual base may be further relocated. Specifically, at least two virtual bases distributed at different locations are displayed in the virtual scene, each virtual base corresponding to a virtual faction including at least one virtual object, and the first virtual object corresponding to a first virtual base; a map of the virtual scene is displayed, and an identifier corresponding to the first virtual base and at least one available location for relocation are displayed in the map of the virtual scene; and the first virtual base is relocated from a first location in the at least one available location for relocation to a second location in the at least one available location for relocation in response to a relocating operation on the first virtual base.

For example, FIG. 11 is a schematic diagram of a map of a virtual scene according to an embodiment of this disclosure. According to FIG. 11, a map in a dashed box 1101 is a map in a virtual scene, and an identifier in a dashed box 1102 is an identifier corresponding to a first virtual base. The identifier corresponding to the first virtual base and the at least one available location for relocation are displayed in the map in the virtual scene, and the first virtual base is relocated from the first location to the second location.

In actual implementation, after the first virtual base is relocated from the first location in the at least one available location for relocation to the second location in the at least one available location for relocation, the first virtual base is displayed at the second location of the virtual scene in response to a confirmation instruction for the relocating operation. The confirmation instruction for the relocating operation may be triggered by a confirmation function item. Specifically, after the first virtual base is relocated from the first location in the at least one available location for relocation to the second location in the at least one available location for relocation, a confirmation function item for confirming that the relocating is completed is displayed, and then it is confirmed, in response to a trigger operation on the confirmation function item, that the relocating operation is completed, so that the confirmation instruction for the relocating operation is triggered.

According to the foregoing embodiment, a location of the virtual base in the virtual scene changes, to increase diversity of an interaction process in the virtual scene, and improve user's immersion and interaction experience, thereby improving human-computer interaction efficiency and utilization of a hardware resource of an electronic device.

In some embodiments, in addition to acquiring the pickable item at a location at which the pickable item is displayed, the first virtual object may also steal a target pickable item stored at a target location corresponding to the second virtual object. Specifically, the first virtual object is controlled to move to the target location corresponding to the second virtual object in response to a movement instruction for the first virtual object, the target location corresponding to the second virtual object being configured for storing the target pickable item; duration of the first virtual object being at the target location corresponding to the second virtual object is displayed; and when the duration reaches a duration threshold, the first virtual object is controlled to pick up the target pickable item stored at the target location corresponding to the second virtual object.

A process of determining whether the duration reaches the duration threshold is, specifically, acquiring duration of the first virtual object being at the target location corresponding to the second virtual object, comparing the duration with the duration threshold, and when a comparison result indicates that the duration of the first virtual object being at the target location corresponding to the second virtual object reaches the duration threshold, controlling the first virtual object to pick up the target pickable item stored at the target location corresponding to the second virtual object.

In actual application, in addition to acquiring the pickable item at the location at which the pickable item is displayed, the first virtual object may also steal the target pickable item stored at the target location corresponding to the second virtual object. More manners to acquire the pickable item are added, to improve diversity of an interaction process in the virtual scene and interaction initiative of the user in the virtual scene, thereby improving gaming experience of the user.

In some other embodiments, a process of stealing the target pickable item stored at the target location corresponding to the second virtual object may be controlling the first virtual object to move to the target location corresponding to the second virtual object in response to the movement instruction for the first virtual object, the target location corresponding to the second virtual object being configured for storing the target pickable item; and displaying a control configured to steal the target pickable item, and controlling the first virtual object to pick up the target pickable item stored at the target location corresponding to the second virtual object in response to a trigger operation such as clicking/tapping or touching and holding on the control.

The process of stealing the target pickable item stored at the target location corresponding to the second virtual object may alternatively be a combination of the foregoing two processes. To be specific, the first virtual object is controlled to move to the target location corresponding to the second virtual object in response to the movement instruction for the first virtual object, the target location corresponding to the second virtual object being configured for storing the target pickable item; the control configured to steal the target pickable item is displayed; the trigger operation such as clicking/tapping or touching and holding on the control is received, and the duration of the first virtual object being at the target location corresponding to the second virtual object is displayed; and when the duration reaches the duration threshold, the first virtual object is controlled to pick up the target pickable item stored at the target location corresponding to the second virtual object. The process of stealing the target pickable item stored at the target location corresponding to the second virtual object includes but is not limited to the foregoing three processes. Details are not described in embodiments of this disclosure.

In some embodiments, when the second virtual object steals a target pickable item stored at a target location corresponding to the first virtual object, prompt information that the target pickable item is acquired is displayed, the prompt information being configured for prompting that the second virtual object performs an acquisition operation on the target pickable item stored at the target location; and the first virtual object is controlled to perform a target operation in response to a control instruction for the first virtual object, the target operation being configured for interrupting the acquisition operation of the second virtual object. For example, when the target location corresponding to the first virtual object is the first virtual base, when the second virtual object enters the first virtual base, or the second virtual object reaches a center location of the first virtual base, the prompt information that the target pickable item is acquired is displayed, so that the first virtual object interrupts an operation of the second virtual object to acquire the target pickable item in time before duration the second virtual object is in the first virtual base reaches the duration threshold.

According to the foregoing embodiment, when the second virtual object steals the target pickable item stored at the target location corresponding to the first virtual object, the prompt information that the target pickable item is acquired is displayed, so that the first virtual object interrupts the operation of the second virtual object to acquire the target pickable item in time, to increase diversity of an interaction process in the virtual scene, and improve user's immersion and interaction experience, thereby improving human-computer interaction efficiency and utilization of a hardware resource of an electronic device.

The target operation performed by the first virtual object and configured for interrupting a process of the second virtual object acquiring the target pickable item may be to attack the second virtual object. Specifically, the first virtual object moves to the second virtual object in response to the movement instruction for the first virtual object. The first virtual object is controlled to perform an attack operation on the second virtual object in response to the control instruction for the first virtual object, so that the process of the second virtual object acquiring the target pickable item is interrupted. After the first virtual object kills the second virtual object, the process of the second virtual object acquiring the target pickable item is ended. Alternatively, the target operation performed by the first virtual object and configured for interrupting the process of the second virtual object acquiring the target pickable item may be to relocate the first virtual base corresponding to the first virtual object when the target location corresponding to the first virtual object is the virtual base. A process of relocating the first virtual base here is as described above. Details are not described herein.

According to the foregoing embodiment of this disclosure, the first virtual object in the first interaction state and the pickable item are displayed in the virtual scene. The first virtual object is controlled to switch from the first interaction state to the second interaction state when the first virtual object picks up the pickable item, so that the first virtual object in the second interaction state cannot use the target interaction manner to interact with the second virtual object, and in addition, the pickable item is stored at the target location in the virtual scene. In this way, when the virtual object picks up the pickable item, the interaction state of the virtual object is switched to a new interaction state that limits the interaction manner, so that the virtual object in the new interaction state transports the pickable item to the target location to store the pickable item. An interaction process is implemented by using the pickable item to improve utilization of an item in the virtual scene, thereby improving utilization of a hardware processing resource and a display resource of the electronic device.

The following describes embodiments of this disclosure in an actual application scenario.

In most shooting games in related art, game modes include a game mode with shooting and killing an enemy as a task goal, a game mode without shooting and killing an enemy as a task goal such as escorting a target point or occupying a target point, and a game mode with collecting an item as a task goal to win. However, for the first game mode, completion of the task goal and victory or defeat of an entire game are mainly determined based on shooting, kills, rankings, and the like. For the second game mode, it is only a disguised limitation on a region and a condition for the player to battle. Essentially, killing by shooting is still a core activity of the player. For the third game mode, shooting is not changed as a first core element for the player at any time of the game. In other words, a micro activity and battle manner of the player never change. In other words, core activities encouraged for a player by most shooting games invariably involve direct battle, that is, achieving a kill through shooting. However, engaging exclusively in a mode of battle by using shooting as a first core element leads to a monotonous interaction process for the player. Consequently, human-computer interaction efficiency is low.

In view of this, this disclosure provides a pickable item-based interaction method, with a mode of a core task goal of collecting a core (to simplify and facilitate understanding, hereinafter collectively referred to as a virtual ball, that is, a pickable item) to send the core to a storage point (a target location). Specifically, a ball is generated at a random location in a map (a virtual scene) over time, and a player (a virtual object) needs to touch the ball, carry the ball, and transport the ball to a base for storage. A team to first collect ten balls wins. In addition to collecting, there are two most critical parts. The first part is that when the player carries the virtual ball, a battle mode (an interaction state) of the player changes, a shooting capability (a target interaction manner) is lost, and a movement capability and a close battle capability are enhanced. The second part is interactivity between the virtual ball and the base. In addition to transporting the virtual ball to own base, there are also rich interaction operations, such as throwing the virtual ball, stealing the virtual ball from an enemy base, transferring own base, thereby bringing more possibilities to a match, and more importantly, providing the player with an opportunity to create more possibilities for the player.

The following describes the technical solution of this disclosure from a product side.

First, a mode process of the virtual scene is described.

In some embodiments, there may be four factions (also referred to as teams) in the virtual scene. Virtual bases of all factions are fixed in four directions of the virtual scene at the beginning of a game (in other words, when the virtual scene just begins running). A virtual object controlled by a player is born and resurrected in the virtual base. The core (such as the virtual ball which corresponds to the foregoing pickable item and is a target that the four factions compete for in the virtual scene) may be refreshed in the map as a game progress (in other words, the virtual ball is continuously generated in the map as the game progresses, for example, the virtual ball may be randomly refreshed in the map). In addition, each virtual object can only carry one virtual ball at the same time, and when the virtual object dies, the virtual ball held by the virtual object falls on the spot. The player may control the virtual object to transport virtual balls scattered in the virtual scene to the virtual base of own faction. The faction to first store a set quantity (for example, 10) of virtual balls wins.

The following describes a basic rule of the virtual scene.

In some embodiments, maximum time for the virtual scene to run may be preset, such as 35 minutes. A quantity of clients connected to the virtual scene may be 4×4=16 (to be specific, there are a total of 16 players in a game, and the 16 players are assigned to four different teams), and a goal of the faction to win may be that a quantity of virtual balls stored in the virtual base reaches a quantity threshold (for example, 10).

The following continues to describe a rule of the virtual base.

In some embodiments, the virtual bases of the factions have fixed locations at the beginning of a game, for example, may be separately distributed in four different directions in the map of the virtual scene. In addition, virtual objects in each faction are born and resurrected in a virtual base of a corresponding faction, and the virtual objects in each faction need to transport the virtual ball back to the virtual base of own faction for storage. In addition, as the virtual scene runs, at least one fixed point (corresponding to the foregoing target location) may be displayed in a map control, and the virtual base may be relocated to the at least one fixed point. In addition, the player may further interact with a virtual base of an opposing faction to acquire the virtual ball from the virtual base of the opposing faction. For example, the player may control the virtual object to enter the virtual base of the opposing faction, and then acquire the virtual ball stored in the virtual base of the opposing faction in response to an item acquisition instruction triggered based on an interaction operation such as clicking/tapping or touching and holding performed by the player. Alternatively, the item acquisition instruction may be triggered by another manner. Specifically, after controlling the virtual object to enter the virtual base of the opposing faction, the player keeps duration the virtual object stays in a target region of the virtual base of the opposing faction to reach a duration threshold (for example, five seconds), so that the item acquisition instruction is triggered to acquire the virtual ball stored in the virtual base of the opposing faction. Alternatively, the item acquisition instruction is triggered by a combination of the foregoing two manners. To be specific, after controlling the virtual object to enter the virtual base of the opposing faction, the player controls the virtual object to enter the target region in the opposing faction, receives the interaction operation such as clicking/tapping or touching and holding performed by the player, and then keeps the duration the virtual object stays in the target region of the virtual base of the opposing faction to reach the duration threshold (for example, five seconds), so that the item acquisition instruction is triggered. A manner for acquiring the virtual ball stored in the virtual base of the opposing faction includes but is not limited to the foregoing three manners. Details are not described in embodiments of this disclosure.

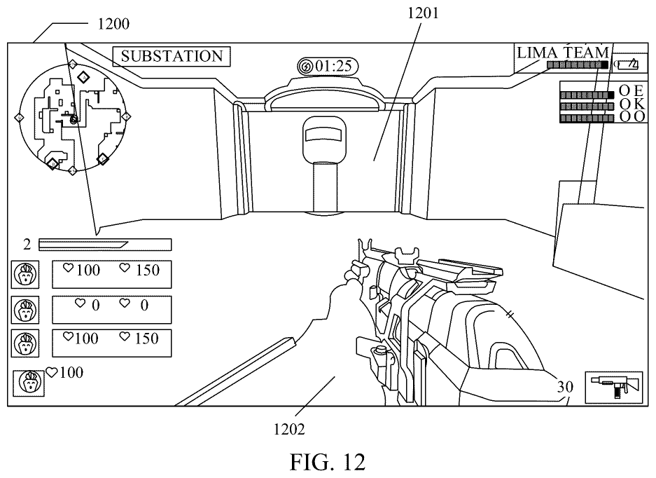

For example, FIG. 12 is a schematic diagram of an application scenario of a pickable item-based interaction method according to an embodiment of this disclosure. As shown in FIG. 12, a virtual base 1201 of a first faction and a first virtual object 1202 (for example, the first virtual object) born in the virtual base 1201 of the first faction are displayed in a virtual scene 1200.

The following continues to describe a core generation logic of the virtual ball.

In some embodiments, as the game progresses, a dimensional storm is generated at a random location in a map (the virtual scene). In other words, terrain of a region changes to one of several fixed preset styles. Then, the virtual ball is generated at a random location in the region. In addition, after a virtual object carrying the virtual ball is killed, the virtual ball carried by the virtual object stays at the spot. The virtual ball stored in a base disappears and is recorded as a score. Moreover, the player may spend a specific amount of time to steal the virtual ball at an enemy base (the target location corresponding to the second virtual object), and after success, the player may change into a state of carrying the virtual ball. In addition, a total quantity of balls produced in the entire map is equal to a sum of a quantity of stored virtual balls, a quantity of virtual balls being carried by the player, and a quantity of unowned virtual balls left somewhere in the map.

The following continues to describe core interactivity of the virtual ball.

In some embodiments, when touching the virtual ball in a non-ball-holding state, the virtual object automatically picks up and carries the virtual ball at the same time. The virtual object loses a capability to hold a gun to shoot when carrying the virtual ball, and is in a ball-holding state. For example, movement speed and a jump height in the ball-holding state are slightly increased, a function of a left button in the ball-holding state becomes an enhanced close battle attack, and a function of a right button in the ball-holding state becomes throwing the ball.

The following continues to describe a tactical possibility derived from a core mechanism of the virtual ball.

In some embodiments, using a changing attack mode and throwability of the core, that is, the virtual ball, a variety of different types of tactical gameplay may be derived, some of which are revolutionary for a shooting game. A combination of the enhanced close battle and a displacement skill turns the virtual object into a close battle assassin. In addition, like a football ball guard, the virtual object may throw and run while transporting the virtual ball without losing the shooting capability. In addition, in an emergency, the virtual object may even throw the virtual ball towards an enemy (such as the second virtual object) to cause the enemy to lose the shooting capability, and then use a gun to shoot the enemy off guard. In this way, a plurality of types of interactivities of the mechanism provide the game with more possibilities.

The following describes the technical solution of this disclosure from a technical side.

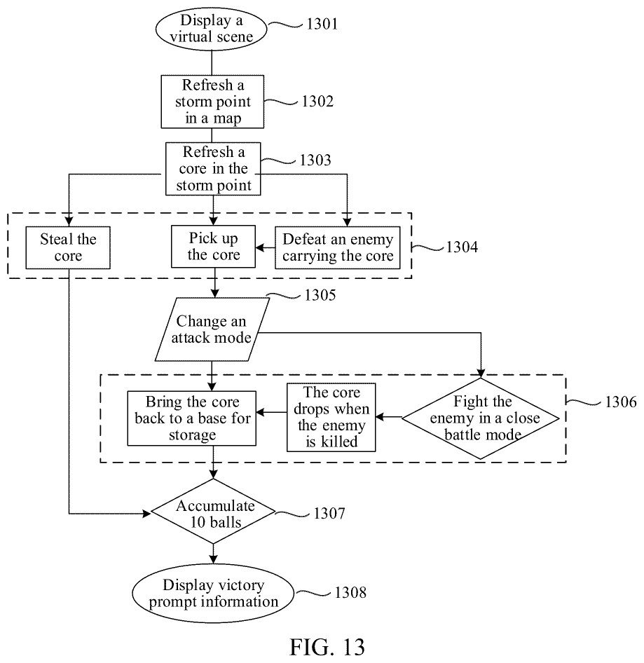

The following describes the pickable item-based interaction method according to an embodiment of this disclosure with reference to FIG. 13. For example, FIG. 13 is a schematic flowchart of a pickable item-based interaction method according to an embodiment of this disclosure. This is described with reference to operations shown in FIG. 13. According to FIG. 13, the pickable item-based interaction method provided in this embodiment of this disclosure is implemented by operation 1301 to operation 1308.

Specifically, first, the virtual scene is displayed in response to a trigger operation on a game start function item, and game start time is recorded at the same time. A coordinate in the map is randomly selected at a fixed time point, and a storm point is generated in a cone-shaped region with the coordinate as a center to change terrain of the map. In a storm point region, the coordinate is randomly selected again to generate the core (that is, the virtual ball). When the virtual object is contact with a collision box of the core, the virtual object automatically picks up the core and switches to a core-carrying state. Then, in the core-carrying state, the virtual object loses the shooting capability and enhances movement speed and a jumping capability. At the same time, functions of the left and right mouse buttons are replaced. For example, the function of the left mouse button is replaced with enhanced close battle attack, and the function of the right mouse button is replaced with throwing the core. After the core is thrown, the virtual object is switched to a gun-holding state. At this stage, the virtual object may use the state to transport the core back to the base, or select another tactic to acquire the core and then transport the core back to the base. For example, the virtual object may interact with a base of an enemy team that stores cores greater than or equal to one. If staying within an enemy base range for a period, the virtual object may successfully steal a core. In this case, the cores stored by the enemy team decreases by one, and the virtual object changes from the gun-holding state to the core-carrying state. An enemy virtual object receives an alarm prompt when the core is stolen, so that the enemy virtual object may actively interact with a neutral base to relocate the base to interrupt a stealing activity, or may kill or drive the virtual object stealing the core out of the base to interrupt the stealing activity. Finally, when a quantity of real-time stored cores of a specific faction reaches 10, the faction wins, and victory prompt information prompting that the faction wins is displayed.

In this way, a new direction is provided for a related shooting game to change a task goal from simply killing as a core to a task goal core with more tactical decisions. In addition, an interesting and rich gameplay system such as changing a battle manner, snatching, and stealing is made around a task goal system. This greatly improves tactical decision-making space of the game and a direction of an activity and a possibility of the user to provide the user with more sources of a sense of accomplishment, and gets rid of a limitation of a single battle-based gameplay. In this way, a target user group is oriented to a wide and comprehensive group, thereby providing better gaming experience for more users.

According to the foregoing embodiment of this disclosure, the first virtual object in the first interaction state and the pickable item are displayed in the virtual scene. The first virtual object is controlled to switch from the first interaction state to the second interaction state when the first virtual object picks up the pickable item, so that the first virtual object in the second interaction state cannot use the target interaction manner to interact with the second virtual object, and in addition, the pickable item is stored at the target location in the virtual scene. In this way, when the virtual object picks up the pickable item, the interaction state of the virtual object is switched to a new interaction state that limits the interaction manner, so that the virtual object in the new interaction state transports the pickable item to the target location to store the pickable item. An interaction process is implemented by using the pickable item to improve utilization of an item in the virtual scene, thereby improving utilization of a hardware processing resource and a display resource of the electronic device.

The following continues to describe an structure in which the pickable item-based interaction apparatus 455 provided in embodiments of this disclosure is implemented as a software module. In some embodiments, as shown in FIG. 2, the software module in the pickable item-based interaction apparatus 455 stored in the memory 440 may include:
a display module 4551, configured to display, in an interaction match in a virtual scene, a first virtual object in a first interaction state and a pickable item, the first interaction state being a state in which the first virtual object can interact with a second virtual object in a target interaction manner;
a first control module 4552, configured to control the first virtual object to switch from the first interaction state to a second interaction state when the first virtual object picks up the pickable item, the second interaction state being a state in which the first virtual object cannot interact with the second virtual object in the target interaction manner; and
a second control module 4553, configured to store the pickable item when the first virtual object in the second interaction state is located at a target location in the virtual scene.

In some embodiments, the display module 4551 is further configured to display, in the virtual scene, a virtual natural element belonging to a natural phenomenon; and control the virtual natural element to be converted into the pickable item when a condition for converting the virtual natural element is satisfied.

In some embodiments, the display module 4551 is further configured to control the first virtual object to move toward the virtual natural element in response to a movement instruction for the first virtual object; and control the virtual natural element to be converted into the pickable item when the first virtual object is within an induction region of the virtual natural element.

In some embodiments, the apparatus further includes a third control module. The third control module is configured to control the first virtual object to move toward the pickable item in response to the movement instruction for the first virtual object; and control the first virtual object to pick up the pickable item when the first virtual object is located in an induction region of the pickable item.

In some embodiments, the apparatus further includes a fourth control module. The fourth control module is configured to display an interaction task corresponding to the pickable item when the first virtual object is within the induction region of the pickable item; control the first virtual object to perform the interaction task in response to a control instruction for the first virtual object; and control the first virtual object to pick up the pickable item when the interaction task is completed.

In some embodiments, the apparatus further includes an avoiding module. The avoiding module is configured to control the first virtual object to perform target motion in response to a motion instruction for the first virtual object when the second virtual object performs an attack operation on the first virtual object in the target interaction manner, the target motion being for enabling the first virtual object to avoid the attack operation.

In some embodiments, the apparatus further includes a transferring module. The transferring module is configured to control the pickable item to be transferred from the first virtual object to the second virtual object when the first virtual object is killed by the attack operation performed by the second virtual object.

In some embodiments, the apparatus further includes a first throwing module. The first throwing module is configured to control the first virtual object to throw the pickable item to a third virtual object in response to a throwing instruction for the pickable item, the throwing being for transferring the pickable item from the first virtual object to the third virtual object, and the third virtual object and the first virtual object belonging to a same faction.

In some embodiments, the apparatus further includes a second throwing module. The second throwing module is configured to control the first virtual object to throw the pickable item toward the second virtual object in response to the throwing instruction for the pickable item when the second virtual object uses a target item to perform the attack operation on the first virtual object; and control the second virtual object to switch from the first interaction state to the second interaction state when the pickable item is thrown to the second virtual object.

In some embodiments, the second throwing module is further configured to control the first virtual object to switch from the second interaction state to the first interaction state; and control, in response to an interaction instruction for the first virtual object, the first virtual object to interact with the second virtual object by using the target item.

In some embodiments, at least two factions exist in the virtual scene, each faction has a corresponding virtual base in the virtual scene, the at least two factions each have a picking task for the pickable item, and the target location is a virtual base corresponding to a faction to which the first virtual object belongs. The apparatus further includes a first prompt module. The first prompt module is configured to display victory prompt information when a quantity of target pickable items stored in the faction to which the first virtual object belongs reaches a quantity threshold, the victory prompt information being configured for prompting that the faction to which the first virtual object belongs wins the picking task.

In some embodiments, the display module 4551 is further configured to periodically generate, in the virtual scene, the pickable item, and display the generated pickable item after each generation. The apparatus further includes a second prompt module. The second prompt module is configured to display, when the first virtual object is in the second interaction state, picking prompt information in response to the first virtual object picking up another pickable item in the virtual scene, the picking prompt information being configured for prompting that a quantity of pickable items carried by the first virtual object reaches a quantity threshold.

In some embodiments, the apparatus further includes a relocating module. The relocating module is configured to display, in the virtual scene, at least two virtual bases distributed at different locations, the first virtual object corresponding to a first virtual base; and display a map of the virtual scene, and display, in the map of the virtual scene, an identifier corresponding to the first virtual base and at least one available location for relocation; relocate the first virtual base from a first location in the at least one available location for relocation to a second location in the at least one available location for relocation in response to a relocating operation on the first virtual base; and display the first virtual base at the second location of the virtual scene in response to a confirmation instruction for the relocating operation.

In some embodiments, the apparatus further includes a fifth control module. The fifth control module is configured to control the first virtual object to move to a target location corresponding to the second virtual object in response to the movement instruction for the first virtual object, the target location corresponding to the second virtual object being configured for storing a target pickable item; display duration of the first virtual object being at the target location corresponding to the second virtual object; and control, when the duration reaches a duration threshold, the first virtual object to pick up the target pickable item stored at the target location corresponding to the second virtual object.

In some embodiments, the apparatus includes a third prompt module. The third prompt module is configured to display prompt information that the target pickable item is acquired, the prompt information being configured for prompting that the second virtual object performs an acquisition operation on the target pickable item stored at the target location; and control the first virtual object to perform a target operation in response to a control instruction for the first virtual object, the target operation being configured for interrupting the acquisition operation of the second virtual object.

In some embodiments, the apparatus further includes an area expansion module. The area expansion module is configured to acquire an area of a region corresponding to the target location in the virtual scene, and expand the region, the area of the region being positively correlated with a quantity of target pickable items stored at the target location.

In some embodiments, the target interaction manner is a shooting item-based interaction manner, the first interaction state is a state in which the first virtual object can use a shooting item to shoot the second virtual object, the second interaction state is a state in which the first virtual object can hold the pickable item to attack the second virtual object, the first virtual object belongs to a first faction, the second virtual object belongs to a second faction, and the first faction and the second camp fight against each other in the interaction match.

An embodiment of this disclosure further provides an electronic device. The electronic device includes:
a memory, configured to store computer-executable instructions; and
a processor, configured to implement, when executing the computer-executable instructions stored in the memory, the pickable item-based interaction method according to embodiments of this disclosure.

An embodiment of this disclosure provides a computer program product or a computer program. The computer program product or the computer program includes computer-executable instructions stored on a computer-readable storage medium. A processor of an electronic device reads the computer-executable instructions from the computer-readable storage medium. The processor executes the computer-executable instructions to cause the electronic device to perform the pickable item-based interaction method provided in embodiments of this disclosure.

An embodiment of this disclosure provides a computer-readable storage medium, such as a non-transitory computer-readable storage medium, having computer-executable instructions stored thereon. The computer-executable instructions, when being executed by a processor, cause the processor to perform the pickable item-based interaction method provided in embodiments of this disclosure, for example, the pickable item-based interaction method shown in FIG. 3.

In some embodiments, the computer-readable storage medium may be a memory such as a ferroelectric random access memory (FRAM), a read-only memory (ROM), a programmable ROM (PROM), an electrically programmable ROM (EPROM), an electrically erasable programmable ROM (EEPROM), a flash memory, a magnetic surface memory, a compact disc, or a compact disc ROM (CD-ROM); or may be various devices including one of the foregoing memories or any combination thereof.

In some embodiments, the computer-executable instructions may be in the form of programs, software, software modules, scripts, or code, written in any form of programming language (including compiled or interpreted languages, or declarative or procedural languages), and may be deployed in any form, including being deployed as a standalone program or as a module, component, subroutine, or another unit suitable for use in a computing environment.

As an example, the computer-executable instructions may, but do not necessarily, correspond to a file in a file system, and may be stored as a part of the file that stores other programs or data, for example, stored in one or more scripts in a hypertext markup language (HTML) document, stored in a single file dedicated to the program under discussion, or stored in a plurality of collaborative files (for example, a file that stores one or more modules, subroutines, or code parts).

As an example, the executable instructions may be deployed to be executed on a single electronic device, or on a plurality of electronic devices located in a single location, or on a plurality of electronic devices distributed in a plurality of locations and interconnected through a communication network.

In conclusion, embodiments of this disclosure have the following beneficial effects:

When the virtual object picks up the pickable item, the interaction state of the virtual object is switched to a new interaction state that limits the interaction manner, so that the virtual object in the new interaction state transports the pickable item to the target location to store the pickable item. An interaction process is implemented by using the pickable item to improve diversity of an interaction process in the virtual scene and utilization of an item in the virtual scene, thereby improving utilization of a hardware processing resource and a display resource of the electronic device.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing descriptions are merely used as examples of embodiments of this disclosure and are not intended to limit the protection scope of this disclosure. Any modification, equivalent replacement, or improvement made without departing from the spirit and scope of this disclosure shall fall within the protection scope of this disclosure.

What is claimed is:

1. A method for interaction in a virtual scene, comprising:
displaying a first virtual character in a first interaction state and an interactive item in the virtual scene;
transitioning the first virtual character from the first interaction state to a second interaction state when the first virtual character obtains the interactive item; and
storing the interactive item when the first virtual character reaches a target location in the virtual scene in the second interaction state, wherein, in the first interaction state, the first virtual character is configured to interact with a second virtual character using a target interaction mode, and in the second interaction state, the first virtual character is not configured to interact with the second virtual character using the target interaction mode.

2. The method according to claim 1, wherein
a first set of interaction modes is available to the first virtual character in the first interaction state, the first set of interaction modes including the target interaction mode;
a second set of interaction modes is available to the first virtual character in the second interaction state; and
the first set of interaction modes is different from the second set of interaction modes.

3. The method according to claim 1, wherein the displaying the interactive item comprises:
displaying a virtual environmental element based on a natural phenomenon in the virtual scene; and
transforming the virtual environmental element into the interactive item when a conversion condition is met.

4. The method according to claim 3, wherein the transforming the virtual environmental element comprises:
moving the first virtual character towards the virtual environmental element in response to a movement command; and
converting the virtual environmental element into the interactive item when the first virtual character enters a detection zone of the virtual environmental element.

5. The method according to claim 1, further comprising:
moving the first virtual character towards the interactive item in response to a movement command; and
enabling the first virtual character to obtain the interactive item when the first virtual character enters a detection zone of the interactive item.

6. The method according to claim 5, further comprising:
displaying an interaction task based on the interactive item when the first virtual character enters the detection zone of the interactive item;
executing the interaction task in response to a control command for the first virtual character; and
enabling the first virtual character to obtain the interactive item when the interaction task is completed.

7. The method according to claim 1, further comprising:
performing an evasive action for the first virtual character in response to a motion command when the second virtual character executes an attack action on the first virtual character using the target interaction mode, wherein the evasive action enables the first virtual character to evade the attack action.

8. The method according to claim 7, further comprising:
transferring the interactive item from the first virtual character to the second virtual character when the first virtual character is eliminated by the attack action executed by the second virtual character.

9. The method according to claim 1, further comprising:
transferring the interactive item from the first virtual character to a third virtual character in response to a throw command, wherein the third virtual character belongs to a same group as the first virtual character.

10. The method according to claim 1, wherein the target interaction mode is configured to use a target item, and the method further comprises:
transferring the interactive item from the first virtual character to the second virtual character in response to a throw command when the second virtual character uses the target item to execute an attack action on the first virtual character; and
transitioning the second virtual character from the first interaction state to the second interaction state when the second virtual character obtains the interactive item.

11. The method according to claim 10, further comprising:
transitioning the first virtual character from the second interaction state to the first interaction state when the second virtual character obtains the interactive item; and
enabling the first virtual character to interact with the second virtual character using the target item in response to an interaction command for the first virtual character.

12. The method according to claim 1, wherein the virtual scene includes at least two groups, each of the groups has a corresponding virtual base, and each of the groups has a collection task for the interactive item, wherein the target location is the virtual base corresponding to the group of the first virtual character, and the method further comprises:
displaying victory information when a number of interactive items stored by the group of the first virtual character reaches a threshold, indicating the group of the first virtual character has completed the collection task.

13. The method according to claim 1, wherein the displaying the interactive item comprises:
periodically generating the interactive item in the virtual scene; and
the method further comprises:
displaying pickup alert information when the first virtual character in the second interaction state obtains an additional interactive item in the virtual scene, wherein the pickup alert information indicates the first virtual character has carried a maximum number of interactive items.

14. The method according to claim 1, further comprising:
displaying a plurality of virtual bases at different locations in the virtual scene, wherein the first virtual character corresponds to a first virtual base of the plurality of virtual bases;
displaying a map of the virtual scene with an indicator of the first virtual base and at least one relocation position;
moving the first virtual base from a first position to a second position from the at least one relocation position in response to a relocation command performed on the first virtual base; and
displaying the first virtual base at the second position in the virtual scene in response to a confirmation command for the relocation command.

15. The method according to claim 1, further comprising:
moving the first virtual character to the target location corresponding to the second virtual character in response to a movement command, wherein the target location corresponding to the second virtual character is for storing a target interactive item;
tracking a duration of time when the first virtual character is present at the target location corresponding to the second virtual character; and
enabling the first virtual character to obtain the target interactive item stored at the target location when the duration of time reaches a time threshold.

16. The method according to claim 1, further comprising:
displaying acquisition alert information indicating the second virtual character is attempting to acquire a target interactive item stored at the target location; and
executing a defensive action for the first virtual character in response to a control command, wherein the defensive action is configured to interrupt the second virtual character from obtaining the target interactive item.

17. The method according to claim 1, further comprising:
determining an area of a region corresponding to the target location in the virtual scene; and
expanding the region, wherein the area of the region is positively correlated with a number of target interactive items stored at the target location.

18. The method according to claim 1, wherein the target interaction mode is a shooting-based interaction, in the first interaction state, the first virtual character is configured to use a shooting item to attack the second virtual character, in the second interaction state, the first virtual character is configured to use the interactive item to attack the second virtual character, the first virtual character belongs to a first group, the second virtual character belongs to a second group, and the first group and the second group are opponents in the virtual scene.

19. An apparatus, comprising:
processing circuitry configured to:
display a first virtual character in a first interaction state and an interactive item in a virtual scene;
transition the first virtual character from the first interaction state to a second interaction state when the first virtual character obtains the interactive item; and
store the interactive item when the first virtual character reaches a target location in the virtual scene in the second interaction state, wherein, in the first interaction state, the first virtual character is configured to interact with a second virtual character using a target interaction mode, and in the second interaction state, the first virtual character is not configured to interact with the second virtual character using the target interaction mode.

20. A non-transitory computer-readable storage medium, storing instructions which when executed by a processor cause the processor to perform:
displaying a first virtual character in a first interaction state and an interactive item in a virtual scene;
transitioning the first virtual character from the first interaction state to a second interaction state when the first virtual character obtains the interactive item; and
storing the interactive item when the first virtual character reaches a target location in the virtual scene in the second interaction state, wherein, in the first interaction state, the first virtual character is configured to interact with a second virtual character using a target interaction mode, and in the second interaction state, the first virtual character is not configured to interact with the second virtual character using the target interaction mode.
